(19) United States
(12) Patent Application Publication
(10) Pub. No.: US 2014/0212985 A1
(43) Pub. Date: Jul. 31, 2014

(54) PREPARATION OF REACTION CHAMBERS WITH DRIED PROTEINS

(71) Applicant: Antonius Johannes Josephus Maria Jacobs, Heesch (NL)

(72) Inventor: Antonius Johannes Josephus Maria Jacobs, Heesch (NL)

(73) Assignee: KONINKLIJKE PHILIPS N.V., EINDHOVEN (NL)

(21) Appl. No.: 14/123,968

(22) PCT Filed: Jun. 27, 2012
(86) PCT No.: PCT/IB2012/053243

§ 371 Date: Mar. 6, 2014

(30) Foreign Application Priority Data
Jun. 30, 2011 (EP) 11172051.2

(51) Int. Cl. G01N 1/28

(52) U.S. Cl. CPC G01N 1/28
USPC 436/174; 422/69

(57) ABSTRACT

The present invention relates to a method of applying a spot of an unlabelled biomolecule, e.g. antibody or protein antigen, to a surface of a reaction chamber of a diagnostic assay. This method comprising the steps of applying to the surface of the reaction chamber a solution comprising a sugar and comprising a non-labelled biomolecule, e.g. antibody or protein antigen, and allowing the solution to dry. In this method the biomolecule is in a concentration sufficient to saturate the binding places for a protein on the surface where the solution has been applied to. The present invention relates to a reaction chamber of a diagnostic device for performing a biomolecule, e.g. antibody or protein antigen, based detection assay. Herein,the reaction chamber comprises a detection region with one or more spots of an unlabelled biomoleculespots bound to the detection region. The one or more spots have a diameter of between 0.1 to 0.5 mm. The spot comprises a sugar and a protein and comprises between 0.01 and 0.5 ng biomolecule.

### FIELD OF THE INVENTION

The present invention relates to the manufacture of reaction chambers for biomolecule, e.g. antibody or protein antigen, based detection assays. The present invention relates more in particular to the application of biomolecules, e.g. antibodies or protein antigens, to a surface of a reaction chamber.

### BACKGROUND OF THE INVENTION

Different types of antibody based detection assays have been developed in the last decades. The production of lateral flow sandwich assays typically comprises the application of a zone of an unlabelled antibody on a sheet of material (e.g. nitrocellulose) whereafter the remaining part of the sheet is at least treated with a blocking solution to prevent the binding of analyte or labelled antibody during the assay. The dried sheet is divided into strips and assembled in reaction chambers with openings for the application of a sample and the read-out of the assay. To increase the shelf life of the immobilized antibody, stabilizers such as sugars, salts and carrier proteins are often applied on top of the immobilized unlabelled antibody.

In Elisa assays, a solution with an antibody is applied into a well, whereby the bound and free antibody remains in a solution during the further steps of the immobilization process (blocking, washing and detection).

Modern point of care sandwich assays are performed in miniaturized reaction chambers. In such an assay a sample enters the reaction chamber whereafter the labelled antibody and the analyte are bound. These assays are not based on capillary lateral flow migration of a sample through a membrane. There is accordingly no need to apply the unlabelled antibody as a line within the reaction chamber. To enhance the sensitivity of the assay, the unlabelled antibody is typically applied as a spot. Although these reaction chambers show significant differences with the prior art lateral flow reaction chambers, the application of the unlabelled antibody is still performed using prior art methods, including blocking, washing and stabilization steps.

US2003/0175827 discloses protein microarrays wherein antibodies are applied to a substrate at a concentration between 0.1 and 2.0 mg/ml in a sugar comprising solution. These protein arrays have not been further optimized for antibody based detection assays.

WO2010/086772 discloses immune based assays wherein magnetic particles with antibodies are dried in a sugar comprising solution at a place remote from the detection region of a reaction chamber.

### SUMMARY OF THE INVENTION

Particular and preferred aspects of the invention are set out in the accompanying independent and dependent claims. Features from the dependent claims may be combined with features of the independent claims and with features of other dependent claims as appropriate and not merely as explicitly set out in the claims.

The present invention provides methods wherein an unlabelled biomolecule, e.g. an antibody or a protein antigen, is immobilized to a surface of a reaction chamber. By selecting the appropriate parameters such as biomolecule concentration and buffer composition, the application, drying and preserving of the antibody can be performed in a single step. By selecting the appropriate concentration of biomolecule, there is no need to perform washing steps to remove an excess of unbound biomolecule. By including protein stabilisers, such as sugars, salts and proteins the biomolecule is dried and stored under conditions which guarantee a long shelf life, without a need to apply additional coatings with stabilizing agents.

The samples which are typically used in point of care assays are complex protein mixtures, which by themselves will block aspecific protein binding places in the reaction chamber. This makes a blocking step redundant. In the eventual case that a sample is used which comprises only a limited amount of protein, apart from the analyte of interest, a protein can be added to such sample.

The method of the present invention dramatically decrease the number of manipulation steps and compounds needed in the manufacture of a reaction chamber. The method of the present invention can be used to manufacture reaction chambers for sandwich or competition assays for antibodies or antigens, for example.

One aspect of the present invention relates to methods of applying a spot of an unlabelled biomolecule, e.g. antibody or protein antigen, to a surface of a reaction chamber of a diagnostic assay, the method comprising the steps of:
applying to the surface of the reaction chamber a solution comprising a sugar and comprising a non-labelled biomolecule, and
allowing the solution to dry,
   wherein the biomolecule is in a concentration just sufficient to saturate the binding places for a protein on the surface where the solution has been applied to.

In embodiments of these methods, the solution further comprises a salt and/or buffer.

In embodiments of these methods, the solution further comprises a protein.

In other embodiments of these methods the volume of the applied solution is adapted to obtain a spot with a diameter of between 100 to 500 micrometer.

In other embodiments of these methods, the volume of the solution is between 1 and 10 nanoliter.

In other embodiments of these methods, the solution comprises between 0.01 and 0.5 μg biomolecule per ml solution.

In other embodiments of these methods, wherein the solution is applied by printing methods.

In particular embodiments of these methods, the reaction chamber with the dried biomolecule undergoes no washing steps prior to the application of a sample in said reaction chamber.

In other particular embodiments of these methods, the volume of the solution is adjusted to obtain a circular spot of between 0.005 and 1.0 mm2.

In other particular embodiments of these methods wherein the sugar is sucrose, the salt is KCl, and the protein is bovine serum albumin.

In particular embodiments of these methods the drying is performed by placing the reaction chamber at 37° C.

In other particular embodiments of these methods, a plurality of different unlabelled biomolecules are applied as separate individual droplets at different positions to the surface of the reaction chamber.

In embodiments of these methods, the biomolecule comprises one of the following: antibody, antigen, protein, peptide, small molecule, nucleic acid molecules and/or combinations and/or fragments thereof.

In embodiments of these methods, the biomolecule concentration in the solution is determined by dividing a binding capacity of the surface multiplied with the spot surface size per spot by the volume of solution used per spot.

Another aspect of the present invention relates to a reaction chamber of a diagnostic device for performing a biomolecule, e.g. antibody or protein antigen, based detection assay, wherein the reaction chamber comprises a detection region with one or more spots of an unlabelled biomolecule bound to the detection region, wherein the one or more spots have a diameter of between 0.1 to 0.5 mm, and wherein said spot comprises a sugar, characterised in that a spot comprises between 0.01 and 0.5 ng biomolecule.

In embodiments of these reaction chambers, the spot further comprises a salt.

In embodiments of these reaction chambers, the spot further comprises a protein.

In other embodiments of these reaction chambers, the sugar is sucrose.

In yet other embodiments of these reaction chambers, the salt is KCL and the buffer is for example Bis-tris propane.

In yet other embodiments of these reaction chambers, the protein is bovine serum albumin.

In embodiments of these reaction chambers, the biomolecule concentration in the solution used to print the spot has been determined by dividing a binding capacity of the surface multiplied with the spot surface size per spot by the volume of solution printed per spot.

### DETAILED DESCRIPTION OF THE INVENTION

The present invention will be described with respect to particular embodiments and with reference to certain drawings but the invention is not limited thereto but only by the claims. Any reference signs in the claims shall not be construed as limiting the scope. The drawings described are only schematic and are non-limiting. In the drawings, the size of some of the elements may be exaggerated and not drawn on scale for illustrative purposes. Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The following terms or definitions are provided solely to aid in the understanding of the invention. These definitions should not be construed to have a scope less than understood by a person of ordinary skill in the art.

The methods of the present invention are applicable to the detection of antigens in a sample using two antibodies. A first antibody for the antigen (primary antibody), which is unlabelled is immobilized on a substrate.

A second antibody (secondary antibody) for the same antigen is detectably labelled and is in solution or in suspension. An antigen which is present in a sample will bind to the unlabelled antibody as well as to the labelled antibody. As a consequence the secondary antibody, with its label, becomes immobilized at the substrate at the position where the primary antibody has been immobilized.

The position where the unlabelled antibody is applied on the surface of the reaction chamber is accordingly the position wherein the complex of unlabelled antibody, antigen and labelled antibody is determined and is also referred to a detection region.

The methods of the present invention are also applicable to methods whereby a protein antigen is immobilised on the reaction surface. This protein antigen is identical to the analyte of interest in a sample, or is a polypeptide with similar binding affinities for an antibody against the analyte. For example, the protein antigen can be a domain or antibody binding part of the analyte or can be a chimeric protein carrying an epitope for the antibody against the analyte. Upon entrance of a sample a labelled antibody against the analyte will bind either with the unbound analyte in the sample or with the immobilised protein antigen on the surface of the reaction chamber. Consequently, the less analyte is present in a sample, the more antibody will bind to immobilised antigen, and the more label will be detected.

Immobilised protein antigens are equally suitable for the detection of antibodies in a sample. In such an assay, the antibody in the sample (which is unlabelled) and the labelled antibody will compete for the same immobilised protein antigen.

Different types of detectable labels are known in the art. For instance, the secondary antibody can be coupled to an enzyme with a detectable enzymatic activity (e.g. the conversion of a colourless into a coloured compound. Other detection methods rely on the presence of a chromophoric group (e.g. fluorescent group) on the secondary antibody. In particular detection methods, the secondary antibody is labelled with magnetic particles. For example, antibodies are coupled to a polymer material comprising magnetic material. The magnetic properties of the label allow on the one hand manipulating the secondary antibody (actuation, movement of antigen-antibody complex towards the primary antibody, removal of unbound secondary antibody).

On the other hand, the magnetic particle can be used as a detectable label, either by measuring the magnetic properties of the particle, or by detecting the presence of particles themselves by optical methods (e.g. FTIR (Frustrated Total Internal Reflection)).

The unlabelled antibody or protein antigen solution is applied on a surface of a reaction chamber which has protein binding capacities. Suitable materials include glass and plastics such as polystyrene. When applicable, materials an be functionalized with compounds which allow a reaction with reactive group of a protein (NH, NH₂, COOH, OH, SH, . . . )

In particular embodiments of the invention the detection of bound analytes is performed by optical methods whereby the unlabelled antibody or protein antigen is applied on an optical transparent material such as glass transparent plastics

The description will further refer to methods and devices wherein antibodies or protein antigens are applied on the surface of a reaction chamber. The various embodiments are explained in detail for the application of antibodies but are equally suitable to provide an enabling disclosure for the application of protein antigens.

In the methods of the present invention, primary antibody is applied in a droplet of solution, to obtain a spot with a diameter between 0.1 and 0.5 mm (millimetre).

Particular embodiments cover spots with a diameter of 0.15, 0.20, 0.25, 0.30, 0.40 and 0.45 mm. Depending on the surface tension of the substrate and the size of the envisages spot this implies the spotting of volumes of between 0.05 and 50 nl (nanoliter). Particular embodiments refer to volume of between 0.05 and 1 nl, 0.5 to 5 nl, 2.5 to 10 nl, 5 to 20 nl, 10 to 30 nl and 20 to 50 nl, and combinations thereof.

On the one hand it is the aim to have the spot on the surface saturated with primary antibody. At the other hand, excessive amounts of primary antibody are to be avoided. Unbound primary antibody which is present on the detection region will form a sandwich with the antigen and the secondary labelled antibody. It will however not be detected at the detection region, as it will migrate away for the detection region.

Depending on the theoretical protein binding capacity of the surface of the reaction chamber it is possible to adjust the antibody concentration in the applied solution such that a 1 fold, 1.5 fold, 2 fold, 3 fold or 5 fold excess of antibody is applied compared to the theoretical binding capacity of the substrate. Depending on the properties of the surface and the antibodies the concentration of antibody is 0.10 to 0.75 μg/ml (microgram per millilitre). In particular embodiments the concentration is between 0.10 to 0.25 μg/ml, between 20 to 50 μg/ml, between 0.30 to 0.50 μg/ml or between 0.40 to 0.75 μg/ml. Depending on the volume of the solution and the concentration of the antibody, spots can be obtained which contain from as low as 0.01 ng up to 0.5 ng. Depending on the label on the secondary antibody and the sensitivity of the assay, suitable amounts of primary antibody per spot are in the range between 0.01 ng and 0.1 ng, 0.05 to 0.2 ng and 0.1 to 0.5 ng. In particular embodiments of the present invention, wherein magnetic particles are used, amounts as little as between 0.01 ng and 0.05 ng of primary antibody are sufficient for the detection of an antigen in a blood sample.

The application of a droplet of antibody solution can be done by inkjet printers. European patent applications EP1378359, EP1378360, and EP 1378361 disclose methods of controlling an inkjet print head containing ink, in which an actuation pulse is applied by an electromagnetic transducer in order to eject an ink drop or droplet out of a duct, wherein an electronic circuit is used to measure the impedance of the electromagnetic transducer and to adapt the actuation pulse or a subsequent actuation pulse. Modified versions adapted for the application of proteins are describe in e.g. WO 2007060634 The antibodies which are used are typically monoclonal or polyclonal antibodies raised against an epitope of the invention. As an alternative it equally possible to use natural or synthetic fragments of antibodies which retain their antigen binding properties, such as Fab, Fab2 and ScFv fragments.

As mentioned before, when protein antigens are used, it is sufficient that the protein antigen comprises the epitope of the analyte for the labelled antibody. Accordingly the protein antibody can be a fragment of the analyte comprising the epitope for the labelled antibody or can be a chimeric protein comprising the epitope of the analyte for the labelled antibody.

The antibody solution further comprises a sugar. Suitable sugars which have a stabilizing effect on proteins include sucrose, maltulose, iso-maltulose, lactulose, maltose, lactose, iso-maltose, maltitol, lactitol, palatinit, trehalose, raffinose, stachyose, melezitose and dextran.

Typical concentrations of sugar range from between 0.05% to 5% (w/v). Particular embodiments of the present invention relate to the use of sucrose between about 0.1 and 1.0% (w/v).

During the drying and the reduction in volume the antibody becomes concentrated near the surface and has the opportunity to bind to the surface. With the addition of a stabilising sugar, the antibody comprising solution becomes a solid material attached to the surface wherein the protein is preserved in its native active state. As a consequence there is no further need to apply additional layers of stabilizing material as a protective coating on top of the dried antibody spots. With the presence of a sugar, the solution takes more time to dry compared to a solution without sugar. During the time period to dry the antibodies have sufficient time to interact with the surface of the reaction chamber.

The methods of the present invention further have the advantage that no additional blocking steps have to be performed. The amount of antibody and optional protein that is used is sufficient to occupy all protein bindings site on the surface where the droplet is applied.

A thin layer of hydrophilic solution may be nevertheless applied thereafter on the surface of the cartridge bearing the spots in order to facilitate the entrance and spreading of the sample in the reaction chamber. Such a final coating may improve the situation, especially if the cartridge support is made of a hydrophobic material (e.g. a plastic material). The volume of this hydrophilic solution is lower or in the range of or slightly higher than the inner volume of the cartridge (typically lower than 1 pl for a chamber of about 240 nl) and prevents the need of an extra washing and blocking step of the bonded particles (indeed a washing/blocking step is usually done by rinsing with a volume much larger than the volume of the chamber so as to rinse away the excess of antibodies—e.g. a volume greater than 1 ml for a chamber of about 240 nl). This hydrophilic solution may comprise some sugar (e.g.) sucrose, salt (e.g. KCl) and/or protein (e.g. bovine serum albumin).

The samples which are typically used in these type of detections (e.g. blood, serum, urine, saliva and other body fluids) are generally complex protein mixtures which upon entry of a reaction chamber will occupy any remaining protein binding site. The amount of analyte which may eventually participate in such aspecific protein binding is neglectable and has no substantial effect on the accuracy and sensitivity of an assay.

Methods in accordance with the present invention are very suitable for the production of reaction chambers with separated individual spots of primary antibody. This allows to perform multiplexing assays wherein 2, 4, 6, or even more antigens are determined.

The antibody solution optionally further comprises a salt which has a stabilizing effect on proteins such as potassium chloride, sodium chloride and magnesium chloride.

Particular embodiments of the present invention relate to the use of KCl between about 0.01 and 2% (w/v), even more preferred between 0.05-0.5%.

The antibody solution further optionally comprises a protein which has a stabilizing effect on proteins (carrier protein), such bovine serum albumin. Other carrier proteins known in the art include ovalbumin, keyhole limpet haemocyanin, heat shock proteins (HSP), thyroglobulin, immunoglobulin molecules, tetanus toxoid, purified protein derivative (PPD), aprotinin, hen egg-white lysozyme (HEWL), carbonic anhydrase, gelatin, transferrin, phosphorylase B, beta-galactosidase and myosin.

Particular embodiments of the present invention relate to the use of BSA between about 5 and 15 μgr/ml, more particularly 10 μgr/ml.

Alternatively the concentration of carrier protein is expressed compared to the concentration of primary antibody. Particular embodiments of the present invention relate to a carrier protein/primary antibody ratio between ½, ¼, 1/6 up to 1/10.

The unlabelled antibody solution which is applied on the surface of the reaction chamber is allowed to dry by placing it in a stove at temperatures in between 5 and 50° C., typically at room temperature (20 to 15° C.) or at about 37° C. During the drying process, the antibody becomes concentrated, comes into contact with the surface of the reaction chamber and binds therewith. The presence of sugar and salt in the solution has the advantage that the drying of the liquid takes a sufficient long time to allow binding of the antibody to the surface. Depending on the binding capacity of the surface, the antibody concentration can be adjusted such that at the one hand the surface binds a sufficient amount of antibody to allow detection of an analyte, and on the other hand no unbound antibody remains which would scavenge analyte that would remain undetected.

The inventors further noticed that a blocking step for the coating of the remainder of the surface of the reaction chamber can be omitted. Compared to lateral flow assays and Elisa assays, the surface of the reaction chamber which allows aspecific protein binding can be neglected compared to the amount of protein which is present in a typical sample such as a body fluid. Upon entry of a sample in the reaction chamber the sample and the proteins therein will act as a blocking buffer. The eventual amount of analyte and labelled antibody which binds to the surface of the reaction chamber has no substantial influence on the performance and sensitivity of the assay.

By adding stabilizers like sugars and/or proteins to the print buffer the printed spot dries slowly whereby a lens-shaped spot is formed when all the water is evaporated. Next to the forming of the lens-shape the slowly increasing concentration of components also stabilizes the bound antibodies and thus makes the use of stabilization buffer obsolete. By optimizing (lowering) the antibody concentration in combination with adding salts or proteins the number of unbound antibodies is limited and a good sensitivity is assured.

The methods of the present invention provide an improved quality control on the manufacture because size/shape/position of the spot remains visible. Next to that the spot can be used as liquid sensor check. When the sample enters the chamber the spot dissolves and thus disappears. When (all) the spot(s) has (have) disappeared it is ensured that the chamber has filled completely.

Methods as disclosed in the present invention make it possible to manufacture a reaction cartridge whereby an unlabelled primary antibody is applied as a droplet in a sugar containing solution and dried. No further washing, blocking or provision of stabilising layers is required.

Nevertheless, a thin layer of hydrophilic solution may be applied thereafter on the surface of the cartridge bearing the spots in order to facilitate the entrance and spreading of the sample in the chamber. Such a final coating may improve the situation, especially if the cartridge support is made of a hydrophobic material (e.g. a plastic material). The volume of this hydrophilic solution is lower or in the range of or slightly greater than the inner volume of the cartridge (typically lower than 1 μl for a chamber of about 240 nl) and prevents the need of an extra washing and blocking step of the bonded particles (indeed a washing/blocking step is usually done by rinsing with a volume much larger than the volume of the chamber so as to rinse away the excess of antibodies—e.g. a volume greater than 1 ml for a chamber of about 240 nl). This hydrophilic solution may comprise some sugar (e.g.) sucrose, salt (e.g. KCl) and/or protein (e.g. bovine serum albumin).

After drying of the droplet (and optionally having applied the hydrophilic coating) the element comprising the dried primary antibody can be assembled in a cartridge or device and is ready for use. The sugar which is present in the dried primary antibody spot ensures a long shelf life of the antibody. Upon use the reaction chamber is filled with a protein containing sample comprising the analyte. The secondary antibody may be added to the sample prior to the introduction of the sample into the reaction chamber, or is introduced into the reaction chamber after entry of the sample, to avoid aspecific binding of the secondary antibody to the reaction chamber.

Other arrangements of the systems and methods embodying the invention will be obvious for those skilled in the art.

It is to be understood that although preferred embodiments, specific constructions and configurations, as well as materials, have been discussed herein for devices according to the present invention, various changes or modifications in form and detail may be made without departing from the scope and spirit of this invention.

### Example 1

A polystyrene plate has a typical average binding capacity of about 5 ng/mm² (Data from Nunc). Spotting of 2 nanoliter typically results in a spot with a diameter of about 0.160 mm. The surface of this spot then is 3.14×0.08²=0.02 mm². This would mean that 5×0.02=0.1 ng is used per spot. With a volume of 2 nl this would mean that the concentration in the print solution would be 0.1/2=0.05 mg/ml. The print solution of the present invention comprises 40 μg/ml of antibody and 10 μg/ml of BSA in a solution of 0.5% sucrose, 0.025 M KCl and 0.025 M of a Bis-tris propane buffer (BTP) in combination with a preservative (0.09% NaN₃). The solution dried for >90% within a minute at room temperature. Further drying was performed overnight at 37° C. in a stove with no humidity control and internal air flow. After drying the dried spot has a homogeneous lens-shaped form.

### Example 2

In this embodiment, four spots are printed on a base part. The print solution has a volume of about 2 nl/spot resulting in a spot diameter of 240 μm. The spots are printed in a cavity that functions as a reaction chamber. The print solution contains 40 μg of anti-PTH antibody, 10 μg/ml BSA in a solution of 0.5% Sucrose, 0.025 M KCl, 0.09% NaN₃ in a buffer of 0.025 M BTP pH 6.8. The solution is dried for >90% within a minute at room temperature. Further drying is performed overnight at 37° C. in a stove with internal flow without humidity control. After drying, a laminate is placed on top of the base part. On the laminate, beads are dosed and dried (200 nl) in such way that the dried beads are positioned in the reaction chamber of the base part. The beads are coated with an anti-PTH antibody. The combination of base part and laminate is part of cartridge on which a blood sample (25 μl) can be pipetted, plasma is generated and transported into a reaction chamber. After magnetic actuation of the beads PTH, spiked in the blood sample, binds with the beads as well as with the spotted antibody. After a magnetic wash step unbound beads are removed and the bound beads are measured using FTIR.

1. A method of applying a spot with a diameter of between 100 to 500 μm of an unlabelled biomolecule to a surface of a reaction chamber of a diagnostic assay from a sample, the method comprising the steps of:
applying to the surface of the reaction chamber a solution comprising a sugar and comprising a non-labelled biomolecule, and
allowing the solution to dry,
wherein the biomolecule is in a concentration just sufficient to saturate the binding places for a protein on the surface where the solution has been applied to such that the reaction chamber with the dried biomolecule undergoes no washing steps prior to the application of a determined sample in said reaction chamber, to remove an excess of unbound biomolecules.

2. The method according to claim 1, wherein the solution further comprises a salt and/or buffer.

3. (canceled)

4. The method according to claim 1, wherein the volume of the applied solution is between 1 and 10 nanoliter.

5. The method according to claim 1, wherein the applied solution comprises between 0.01 and 0.5 μg biomolecule per ml solution.

6. (canceled)

7. The method according to claim 1, wherein the biomolecule concentration in the solution is determined by dividing a binding capacity of the surface multiplied with the spot surface size per spot by the volume of solution used per spot.

8. The method according to claim 1, wherein the applied solution further comprises a protein.

9. The method according to claim 1, wherein a plurality of different unlabelled biomolecules are applied as separate individual droplets at different positions to the surface of the reaction chamber.

10. The method according to claim 1, wherein the biomolecule comprises one of the following: antibody, antigen, protein, peptide, small molecule, nucleic acid molecules and/or combinations and/or fragments thereof.

11. A reaction chamber of a diagnostic device for performing a biomolecule based detection assay, wherein the reaction chamber comprises a detection region with one or more spots of an unlabelled biomolecule bound to the detection region, wherein the one or more spots have a diameter of between 0.1 to 0.5 mm, and wherein said spot comprises a dried solution of said unlabeled biomolecule and a sugar, characterised in that a spot comprises between 0.01 and 0.5 ng biomolecule.

12. The reaction chamber according to claim 11, wherein the spot further comprises a salt.

13. The reaction chamber according to claim 11, wherein the spot further comprises a protein.

14. The reaction chamber according to claim 11, wherein the biomolecule comprises one of the following: antibody, antigen, protein, peptide, small molecule, nucleic acid molecules and/or combinations and/or fragments thereof.

15. The reaction chamber according to claim 11, wherein the biomolecule concentration in the solution used to print the spot has been determined by dividing a binding capacity of the surface multiplied with the surface size per spot by the volume of solution printed per spot.

16. The method according to claim 1, wherein the biomolecule is in such a concentration that a 1 fold, 1.5 fold, 2 fold, 3 fold or 5 fold excess of the biomolecule is applied compared to the theoretical binding capacity of the substrate.

17. The method of claim 1, additionally comprising a step of applying a sample to the reaction chamber.
